(19) United States
(12) Patent Application Publication
(10) Pub. No.: US 2013/0270792 A1
(43) Pub. Date: Oct. 17, 2013

(54) BICYCLE

(71) Applicant: Kyunghee PARK, Gwangju (KR)

(72) Inventor: Kyunghee PARK, Gwangju (KR)

(21) Appl. No.: 13/916,579

(22) Filed: Jun. 13, 2013

Related U.S. Application Data
(63) Continuation of application No. PCT/KR2011/009691, filed on Dec. 15, 2011.

(30) Foreign Application Priority Data
Dec. 15, 2010 (KR) 10-2010-0127976

(51) Int. Cl. B62K 21/00

(52) U.S. Cl. CPC B62K 21/00
USPC 280/278; 280/274

(57) ABSTRACT

Provided is a bicycle including: a front wheel section steering bicycle comprising: a front wheel section comprising a handle section, and front wheel stem connected to a lower end of the handle section and provided with a saddle installed at an upper end and a front wheel installed at a lower end thereof; and a rear wheel section comprising a rear wheel stem provided with an upper end hinged to the lower end of the handle section or the front wheel stem via a steering bearing and a lower end at which a rear wheel is installed, which form an X shape, wherein the front wheel section is laterally steered about a ground contact point of the front wheel as a rotary shaft by the hinge when the steering bearing is rotated by steering manipulation of the handle section.

### BACKGROUND

The present invention relates to a bicycle, and more particularly, to a bicycle capable of allowing a user to use and transport the bicycle with little effort and to easily carry the bicycle.

FIG. 1A shows a bicycle which is unstable since a steering unit configured to separately steer a front wheel only is not provided or is inadequate. FIG. 1B shows a bicycle disclosed in Korean Patent Application Laid-Open No. 10-2001-0016444 (published Mar. 5, 2001). The bicycle has no power support point with respect to a steering operation when a front wheel is to be steered, and thus a user should twist his/her whole body or use a reaction of the bicycle. Accordingly, the steering cannot be easily performed by a rider (a user) who is not highly skilled. FIG. 1C shows a bicycle disclosed in Korean Utility Model Application Laid-Open No. 20-1993-19682 (published Sep. 23, 1993). While steering can be performed by rotating a steering handle using a saddle as a support point, since a power-transmission system such as a pedal or the like is laterally rotated with the steering handle, the power transmission system is deviated from a direction in which a user's body is directed, a user's feet cannot easily come in continuous contact with the pedal, and thus an effective force cannot be transmitted.

In particular, when a steering angle is large, it is impossible to step on the pedal.

### SUMMARY

It is an object of the present invention to provide a bicycle capable of minimizing a vehicle body (frame) structure of a bicycle to reduce a weight thereof and reduce a force for carrying the bicycle, minimizing a volume thereof to maximize transportability, and providing comfort for a user's feet when stepping on a pedal.

In order to achieve the aforementioned objects, a bicycle of the present invention includes a front wheel section including a front wheel stem; a saddle installed at an upper end of the front wheel stem; a front wheel installed at a lower end of the front wheel stem, a drive unit configured to drive the front wheel; and a handle section provided with a handle stem installed between the saddle and the front wheel stem and a handle installed at a front end of the handle stem, and

a rear wheel section including a rear wheel stem; a steering bearing installed at an upper end of the rear wheel stem and configured to axially support the front wheel stem; and a rear wheel installed at a lower end of the rear heel stem,

wherein the handle section s laterally steered when the handle is manipulated.

In addition, the front wheel section may be configured to be steered about the steering bearing when the handle is manipulated.

Further, the handle stem may be installed at the front wheel stem, and the steering bearing of the rear wheel stem may be axially supported about the rear end of the handle stem as a steering axis.

When a front wheel of a conventional front wheel drive bicycle is steered, a crank pedal should also be rotated in the same direction to avoid collision with the crank pedal, and thus a movement angle of a rider's leg is deviated from the crank pedal so that a driving force cannot be appropriately transmitted. According to the present invention, the above-mentioned problem can be solved.

In addition, since a user's body can be twisted or tilted in a steering direction, a centrifugal force applied to an opposite side of the steering direction can be easily overcome, and the user can twist and tilt his/her body during the steering and enjoy more dynamic riding.

The scope of the present invention includes another embodiment including the spirit of the present invention, in addition to exemplary embodiments described herein.

### BRIEF DESCRIPTION OF DRAWINGS

FIGS. 1A to 1C are views showing conventional bicycles.

The following relate to embodiments of the present invention.

FIG. 2 is a side view of a first embodiment.

FIG. 3A is an exploded view of a portion of the first embodiment, and FIG. 3B is view showing an operation thereof.

FIG. 4A is a side view showing a second embodiment, and FIG. 4B is a side view showing a third embodiment.

FIG. 5A is a side view of a portion of a fourth embodiment, and FIG. 5B is an enlarged view of the portion of the fourth embodiment (a partial configuration is not shown).

FIG. 6A is a side view of a portion of a sixth embodiment, FIG. 6B is a partially exploded view, and FIG. 6C is a view showing an operation at a bottom surface.

FIG. 7A is a side view of the portion, and FIG. 7B is a view showing an operation thereof.

FIG. 8 is a side view of a seventh embodiment.

FIGS. 9A and 9B are views showing a folding operation of the seventh embodiment.

FIG. 10A is a side view showing a portion of an eighth embodiment, and FIG. 10B is a side view showing a portion of a ninth embodiment.

FIG. 11A is a plan view showing a diagonally looped belt of another embodiment of FIG. 6, FIG. 11B is a plan view showing an operation of the belt, and

FIG. 11C is a plan view showing a linearly looped belt.

The following relate to embodiments of another form of the present invention.

FIG. 12 is a side view.

FIG. 13 is a view showing a steering operation.

FIG. 14A is a side view of a steering manipulation unit 150 using a belt, and FIG. 14B is a view showing a universal joint.

FIG. 15A is a side of an exterior, and FIG. 15B is a partially exploded view.

FIG. 16A is a side view showing a folded state, FIG. 16B is an exploded view showing a folding unit 170, and FIG. 16C is an exploded view of a steering bearing 220.

FIGS. 17A and 17B show rotation s2 of upper and lower ends about the steering bearing 220 as an axis.

FIGS. 18A to 18C show angles (directions) of an axis of the steering bearing 220 or angles of bearings of a housing frame F configured to axially support a rear end of a handle stem 162.

FIG. 19A is a view showing a portion of related components including a steering manipulation unit, FIG. 19B is a partially cut view, and FIG. 19C is a longitudinal cross-sectional view.

FIGS. 20A to 20C are views showing various types of folding units 170 including a partial view of related components including the steering manipulation unit.

FIG. 21A is a partial side view showing a front wheel stem 110, which is bent so that a folding unit is configured outside a steering rotational axis s2 and rotational directions of the front wheel stem and a saddle coincide with each other, and FIG. 21B is a perspective view showing the front wheel stem and peripheral components thereof of another embodiment of the front wheel stem.

FIGS. 22A to 22C are side views showing configurations of various handle stems and steering manipulation units.

FIGS. 23A to 23C are side views showing different inclinations of a front wheel section 100 with respect to a normal line, and FIG. 23D is a view showing an operation of running and steering (direction change).

### DETAILED DESCRIPTION

A bicycle of the present invention includes a handle section; a front wheel stem connected to a rear end section of the handle section and including a saddle installed at an upper end and a front wheel installed at a lower end thereof; and a rear wheel stem connected to the rear end section of the handle section or the front wheel stem and including a rear wheel installed at a lower end thereof, wherein the front wheel stem is laterally steered and rotated (including curving) about an upper end section of the rear wheel stem when the handle section is operated.

A steering manipulation unit is configured such that the front wheel stem is laterally rotated to be steered with respect to a rotational shape of the upper end section of the rear wheel stem when a handle or a handle stem of the handle section is manipulated.

When the rear end section of the handle section is rotatably coupled to the upper end of the rear wheel stem, the handle section can be coupled to the front wheel stem in a foldable X shape.

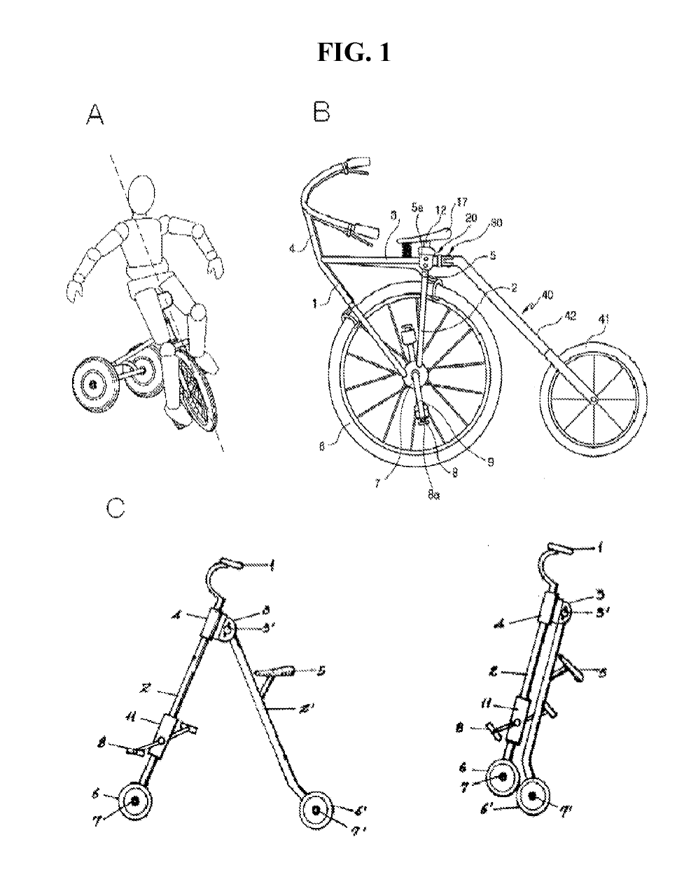

The present invention relates to a bicycle having two or more wheels including front and rear wheels. FIG. 1A shows a trike having three wheels, in which a plurality of rear wheels are disposed in parallel.

The bicycle of the present invention includes a front wheel section 100 and a rear wheel section 200.

The front wheel section 100 includes a front wheel stem 110; a saddle 120 installed at the upper end of the front wheel stem 110; a front wheel 130 installed at the lower end of the front wheel stem 110; a drive unit 140 configured to drive the front wheel 130; and a handle section 160 including a handle stem 162 installed between the saddle 120 and the front wheel stem 110, and a handle 161 installed at a front end of the handle stem 162.

Meanwhile, when the bicycle is manufactured for the purpose of downhill riding, when a separate power unit is installed, or the like, the drive unit may be omitted.

In addition, when the handle stem functions as the handle, a separate handle may be omitted.

The rear wheel section 200 includes a rear wheel stem 210; a steering bearing 220 installed at the upper end of the rear wheel stem 210 and configured to axially support the front wheel stem 110; and a rear wheel 230 installed at a lower end of the rear wheel stem 210.

In addition, the front wheel section and the rear wheel section cross in an X shape, and the crossing point is hinged. According to the above-mentioned configuration, the sections can be folded like scissors. Of course, a stopper pin or the like may be used to configure a locking device to limit a spread range of the X shape. Further, the handle is configured to rotate the front end of the rear wheel section.

The front wheel stem 110 and the rear wheel stem 210 have a rod shape and conventionally formed of a metal, a carbon fiber, a synthetic resin, or the like, and the front and rear wheels 130 and 230 are axially supported at the lower ends thereof

The steering bearing 220 is installed at the upper end of the rear wheel stem 210 and has a tubular shape (a pipe shape). The front wheel stem 110 passes through the steering bearing to be axially supported and fixed to maintain a certain angle with respect to the rear wheel stem 210.

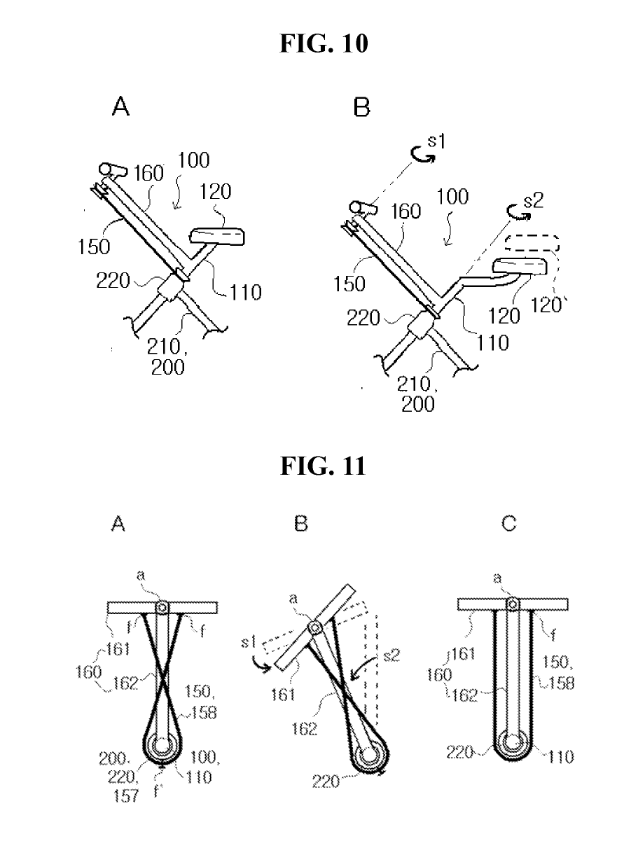

The saddle 120 is conventionally formed of a synthetic resin, a rubber, or the like, and has a shape such that a user can easily step on a pedal 142 of the drive unit 140 while seated on the saddle. As shown in FIG. 10A, when the saddle is disposed at the uppermost end of the front wheel stem 110, the rotary shaft of the front wheel stem 110 coincides with a rotary shaft of a body center of a user (a rider). As shown in FIG. 10B, when the saddle is disposed at a rear side from a center of the front wheel stem 110, the user's body center is disposed at a rear side of a rotary shaft s2 of the front wheel stem 110. Here, the front wheel stem 110 is tilted rearward, and thus a center of gravity of the user seated on a saddle 120′ rotated about the inclined rotary shaft s2 is raised. Here, a tendency to automatically return to an original position is generated by gravity. The steering can be performed by rotating and manipulating (s1) the handle.

The front and rear wheels 130 and 230 include tires 132 and 232 conventionally formed of rubber, a synthetic resin, or the like, and rotary shafts 131 and 231 of the tires.

The front wheel 130 conventionally functions to steer (change a direction of) the bicycle, but in a front wheel drive bicycle, also functions to drive the bicycle by generating a propulsive force. If a drive apparatus such as a motor is installed at a rear wheel side, the rear wheel may be driven.

The drive unit 140 generally includes the pedal 142; a drive sprocket 141; a chain 143; a driven sprocket 144; and a gearbox. In addition, the drive unit is configured as a chainless power transmission system using a combination of gears such as a bevel gear or the like. Of course, other types of drive units may be applied.

When a steering force (a direction change force) is generated by a manual manipulation of the user on the handle or the handle stem 162 with respect to the handle section 160, the steering force is finally transmitted to the front wheel 130 via the front wheel stem 110 to perform the steering. Of course, the handle section shown in the drawing is an example, and other types of handles, handle stems and combinations thereof may be possible. In addition, subsidiary devices generally needed in a bicycle, such as a brake, a speedometer, a horn, and so on, may be added.

Hereinafter, the handle section 160 and a steering manipulation unit 150, which are major components of the present invention, will be described.

First, referring the simplest embodiment of the steering manipulation unit 150 shown in FIG. 7, when the handle 161 is manipulated, only the handle section 160 is independently laterally or vertically moved. Here, the user applies a force in a direction opposite to behavior of the handle section 160 to transmit the force to the front wheel stem 110 via the saddle 120, accomplishing the steering of the front wheel 130. Referring to the embodiment shown in FIGS. 7A and 7B, an inclined shaft 159 having a cam shape and inclined to be axially (a) coupled is provided. When the handle section 160 is rotated (s1), the handle section 160 is moved (s2) toward one of left and right sides due to inclination of the inclined shaft 159. Since the configuration is somewhat insufficient in stability due to movement of the handle section 160 alone, the user intentionally fixes a position of the handle section 160. Of course, a resilient body configured to apply a resistance against rotation of the handle section may be provided to lock both ends thereof to both sides of the inclined shaft 159 to return to the original position.

Next, when the handle 161 is manipulated, a direction of the front wheel section 100 is entirely changed about the steering bearing 220 to secure a steering effect and the handle section becomes stable.

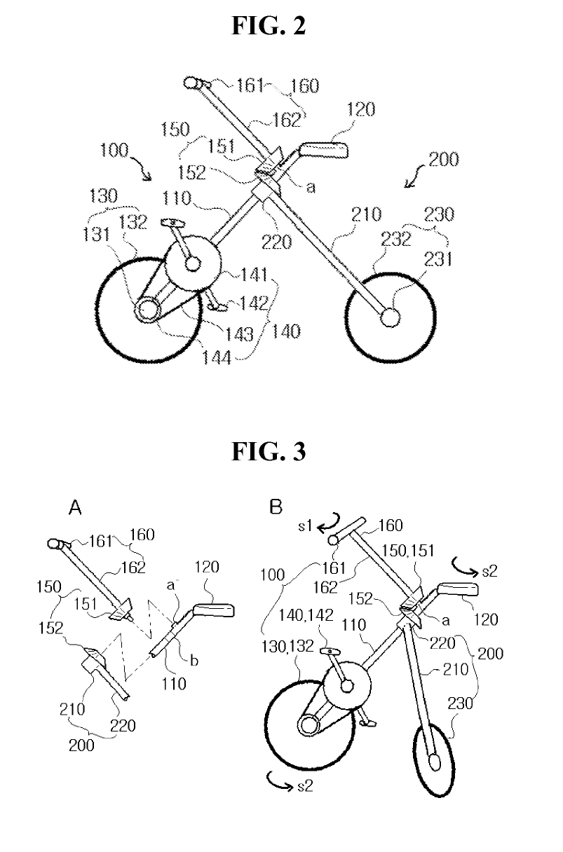

In FIG. 2 and FIG. 3A, the handle 161 is disposed at a front end of (in the front of) the handle stem 162; a rear end of the handle stem 162 is axially supported (a) to be pivoted from the front wheel stem 110; and a gear installed at the rear end of the handle stem 162 and a gear installed at the upper end of the rear wheel stem 210 (or the steering bearing 220) are meshed with each other in a shape of bevel gears 151 and 152. According to the above-mentioned configuration, a steering operation shown in FIG. 3B becomes possible. When the user rotates the handle 161 to perform the steering manipulation (s1), the bevel gears 151 and 152 are operated so that the entire front wheel section 100 is steered and rotated (s2).

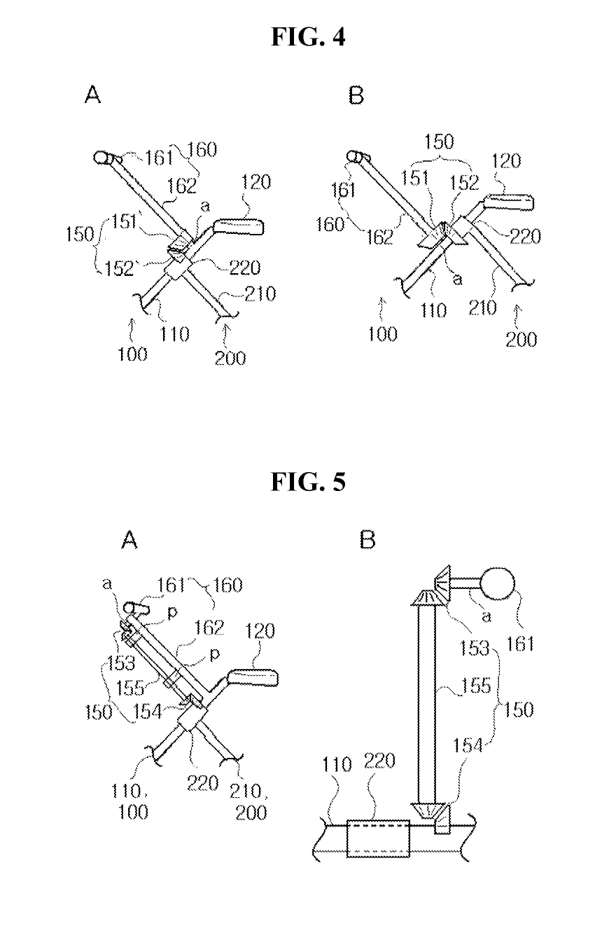

The bevel gears 151 and 152 may have local teeth needed for the steering rotation as shown in FIG. 4A. FIG. 4B shows a configuration in which upper and lower directions are inverted. In this case, since the steering direction of the front wheel section 100 is opposite to a direction of the steering rotation (s2), the bicycle may be used for special purposes such as performance, training, and so on.

In FIGS. 5A and 5B, the rear end of the handle stem 162 and the front wheel stem 110 are integrally formed to be fixed to each other. Here, the handle 161 is separately operated at or rotated about the front end of the handle stem 162. The stems are installed via a shaft a. A gear meshed with the gear of the shaft a is a bevel gear 153 of the front end side. When the handle is manipulated to be steered, a power transmission direction is changed to the front end side the bevel gear 153, and power is transmitted to a bevel gear 154 of the rear end side via a transmission shaft 155. The bevel gear 154 of the rear end side is constituted by a gear installed at the rear end of the transmission shaft 155 and a gear installed at the upper end of the rear wheel stem 210 (or the steering bearing). The front wheel section 100 can be laterally rotated about the steering bearing 220 of the rear wheel section 200 by the steering manipulation transmitted to the rear end side.

The bevel gear is only an example, and may be accomplished by other types of gears or friction wheels.

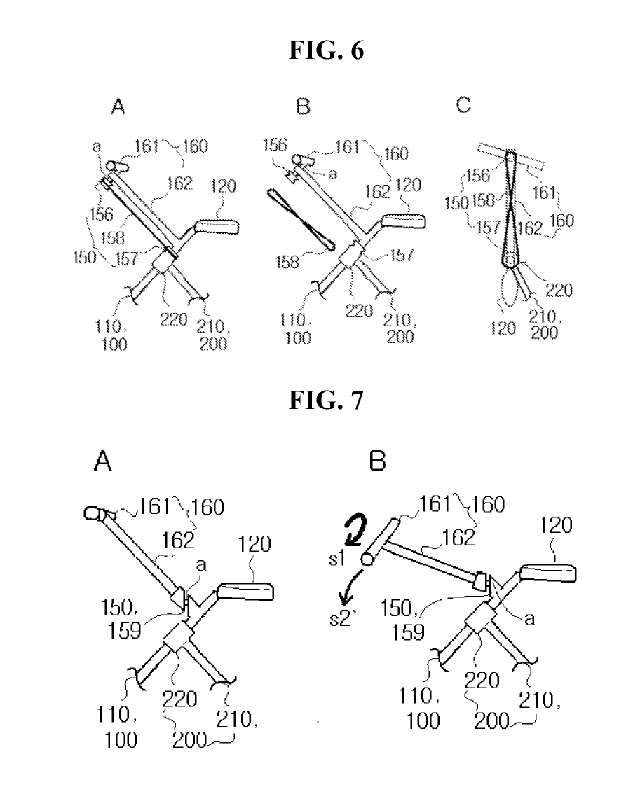

FIG. 6 shows a combination of a belt and a belt pulley (or a chain and a sprocket). As another embodiment of the example shown in FIG. 5, a front end side belt pulley 156 is installed at the rotary shaft a of the handle 161, a rear end side belt pulley 157 is installed at the rear end of the handle stem 162, and a belt 158 is wound on the belt pulleys 156 and 157. The belt 158 may be diagonally looped as shown in the drawing, and a parallel loop is also possible.

In FIG. 11A, as another example of FIG. 6, the front end side belt pulley 156 is removed and both ends of the belt 158 are fixed (f) to sides of the handle 161. Here, as shown in FIG. 11B, when the handle 161 is rotated about the rotary shaft (a) to be steered and manipulated (s1), as shown, the handle stem 162 is steered and rotated (s2) about the steering bearing 220 to steer the front wheel stem. Meanwhile, the belt may be fixed (r) to the rear end side belt pulley 157 or the steering bearing 220. Meanwhile, as shown in FIG. 11C, when the belt is wound, the steering is performed in another direction. Of course, unlike the above-mentioned configuration, the rear end side belt pulley 157 may be removed.

According to the above-mentioned configuration, the user manipulates the handle section to steer the entire front wheel section 100, and thus a direction of the saddle 120 coincides with a direction of the steering. As a result, a riding direction of the user coincides with the steering direction, and thus coincides with the direction of the front wheel and the drive unit. Accordingly, a user's leg does not interfere with (contact) the front wheel during the running (riding), and a direction of the drive unit, in particular, the pedal, coincides with a movement direction of the leg to apply an effective propulsive (driving) operation.

The front wheel drive bicycle of the present invention may include a folding unit configured to fold the bicycle for the purpose of storage, movement, or the like. Since various kinds of folding units are known, these folding units will be recited.

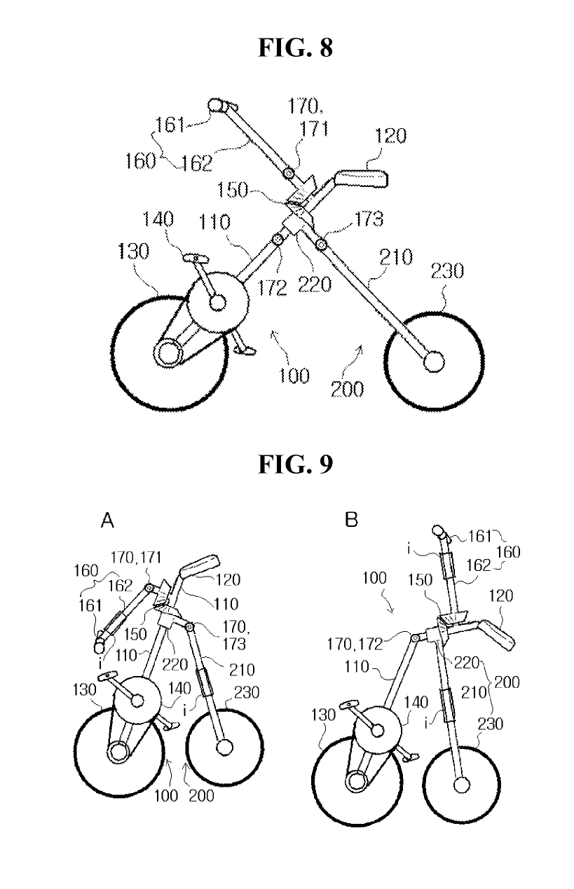

In FIG. 8, a folding unit 170 (171, 172, 173) is shown. The folding unit 170 (171, 172, 173) may be selectively installed at any or all of the handle stem 162, the front wheel stem 110 and the rear wheel stem 210, or may be installed at another member such as the handle. In FIG. 9A, the folding unit 170 (171, 173) is installed at the handle stem 162 and the rear wheel stem 210, and in FIG. 9B, the folding unit 170 (172) is installed at only the front wheel stem 110.

In addition, in FIG. 9, a sliding unit i configured to adjust a length of each portion is shown. The sliding unit i may be installed at a desired portion.

The above-mentioned configuration and components of the present invention correspond to some examples, and other devices and units known or modified by those skilled in the art may be used to accomplish the present invention. For example, the handle 161 may have a T shape as shown in the drawing, or another shape such as a flag pole shape. The handle may be operated through rotation, curving, expansion and contraction, or the like. For example, in the case of a caliper brake used as a bicycle brake, a brake lever of the handle side is gripped to operate a rear brake. As described above, the lever of the handle side is gripped to rotate the front wheel stem 110 from the steering bearing 220 of the rear wheel stem 210. These levers will be recited from the detailed description and the accompanying drawings of Korean Patent Application No. 10-2005-0101608.

A friction wheel, a universal joint, a linkage, or the like, may be applied to the gears and bevel gears g1 and g2.

In addition, in the present invention, the folding unit 170 is disclosed in Korean Patent Application No. 10-1993-0002630, and Korean Utility Model Application Nos.: 20-2001-0006196 and 20-1995-0000166.

The sliding unit i is disclosed in Korean Patent Application No. 10-1996-0027315, and Korean Utility Model Application Nos.: 20-1997-0036108 and 20-2008-0008345, which are incorporated by reference herein.

As described above, in the bicycle of the present invention having the front wheel section and the rear wheel section, which cross in an X shape,

the handle stem is fixed to the front wheel stem, and the steering bearing of the rear wheel stem is axially supported such that the rear end of the handle stem functions as a steering shaft.

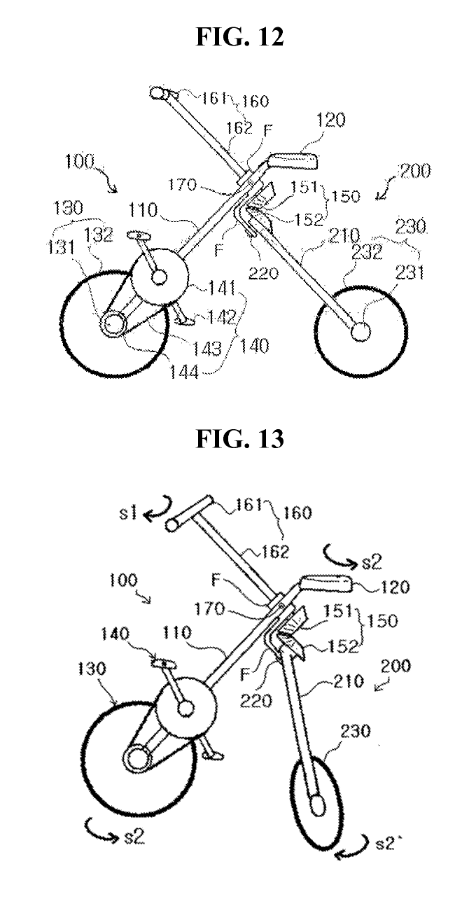

In FIG. 12, the handle stem 162 and the front wheel stem 110 are coupled by the folding unit 170 such as a pivot, a hinge, or the like; and the rear end (or the lower end) of the handle stem and the front end (or the upper end) of the rear wheel stem 210 are pivoted or hinged to constitute the steering bearing 220.

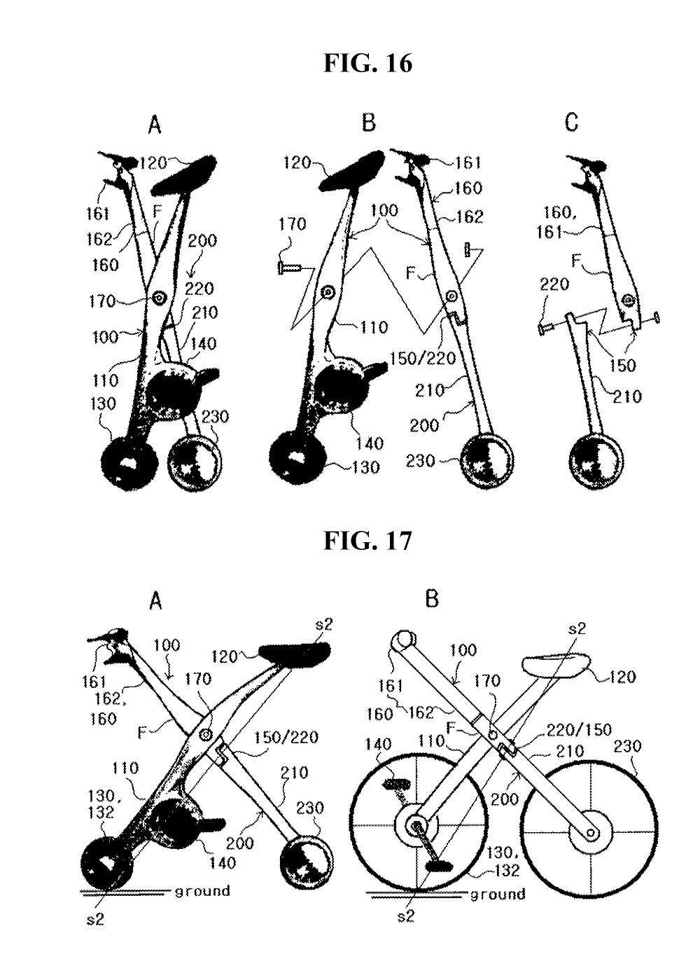

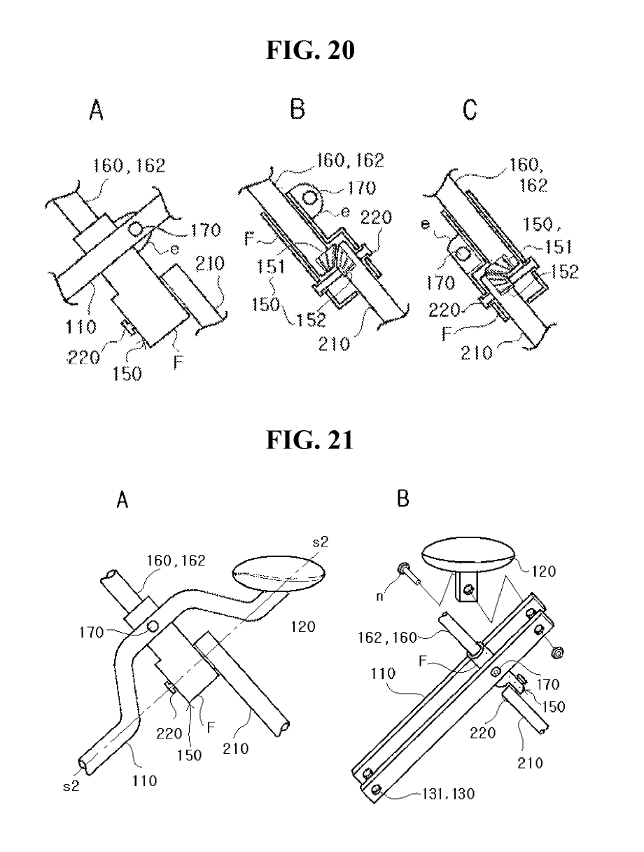

Referring FIGS. 12 to 16 together with FIGS. 19 and 20, the rear end of the handle stem of the handle section 160 is axially supported to enable rotation for steering or handle manipulation from a housing frame F, the gear 151 fixed to the rear end of the handle stem 162 is meshed with the gear 152 formed at the upper end of the rear wheel stem 210 to constitute the bevel gears 151 and 152, the steering bearing 220 is installed at the housing frame F to be axially supported to constitute the steering manipulation unit 150, and the front wheel stem 110 is hinged to the housing frame F to constitute the folding unit 170 folded in a scissors shape as shown in FIG. 16A. Here, the folded state can be maintained or released by the locking apparatus.

Here, a hinge rotary shaft of the folding unit 170 may be installed at an area e extending from the housing frame F as shown in FIG. 20, for the convenience of constitution of the folding unit.

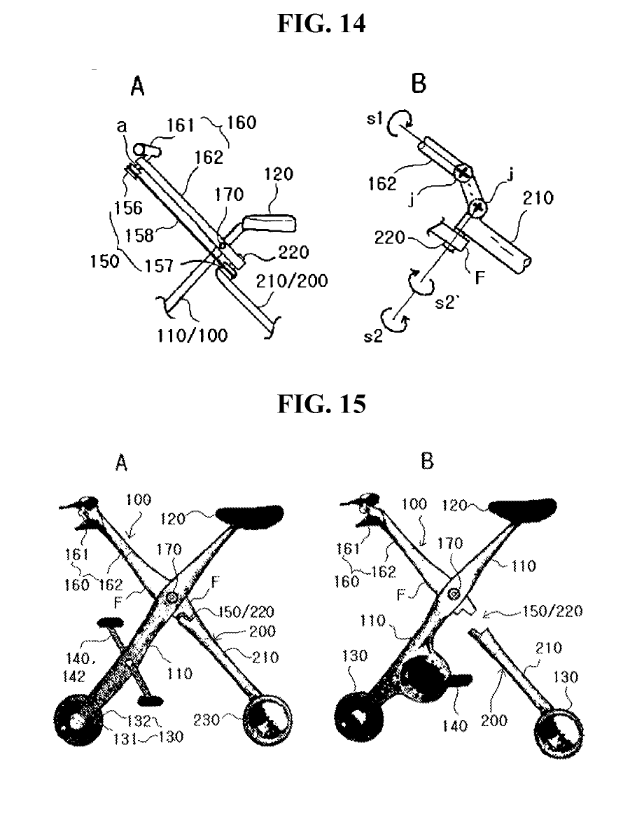

According to the above-mentioned configuration, the steering operation as shown in FIGS. 13 and 14B becomes possible through the steering bearing 220. That is, when the handle 161 and the handle stem 162 are steered and manipulated (s1), power transmitted through the bevel gears 151 and 152 or a universal joint j rotates the rear wheel stem 210 of the rear wheel section 200 about the steering bearing 220 (s2′). Here, when the direction of the rear wheel stem is fixed, the front wheel stem of the front wheel section 100 is inversely rotated (s2), and the entire front wheel section 100 including the handle section 160, the saddle 120 and the front wheel 130 is rotated. The rear wheel section 200 can be easily discriminated with reference to the exploded view of FIG. 15B.

As shown in FIG. 14A, the steering manipulation unit 150 may be constituted by a timing belt (including a chain) and a belt pulley (including a sprocket), and a belt 158 is wound on a belt pulley 156 installed at the handle 161 side and a belt pulley 157 installed at the rear end of the handle stem 162.

In FIG. 14B, the case in which the bevel gear is replaced with a universal coupling (a cruciform joint or a universal joint) j is simply shown (since the universal coupling is a conventional mechanical element, detailed illustration thereof is omitted). One or a plurality of universal couplings are combined to change a rotational direction instead of the bevel gear. The universal coupling may be replaced with a coupling formed of a flexible material. In addition, the bevel gear may be replaced with another known combination of gears, another mechanical element such as a friction wheel, or the like. In other words, any mechanical element configured to normally or inversely transmit rotation (including curve) or transmit the rotation at different angles may be used for the configuration of the present invention. In the present invention, such an element is referred to as a steering manipulation transmission element.

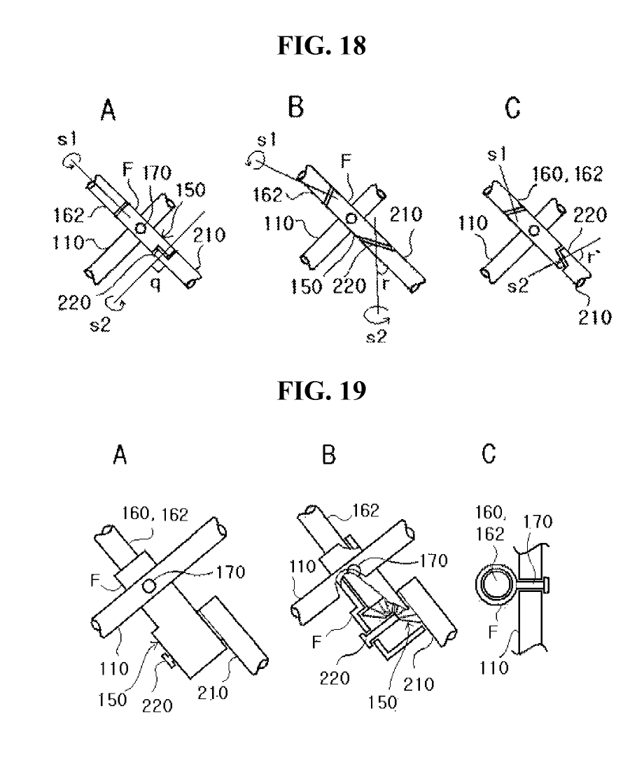

Meanwhile, an angle of the shaft of the steering bearing 220 may be inclined according to necessity. For example, referring to FIG. 18, the angle may be a normal angle q as shown in FIG. 18A, or may be an inclined angle r or an inversely inclined angle r′ as shown in FIGS. 18B and 18C; and an inclined angle may be similarly applied even when the handle stem is axially steered and rotated. In FIG. 18, the inclined angle may be used to allow a ground contact point of the front wheel to coincide with the rotary shaft of the saddle, or may be used for special purposes such as performance of extreme sports, as can be seen from FIG. 17.

In addition, in order to allow the handle stem to coincide with the ground contact point of the front wheel, the saddle may be moved forward or rearward to be fixed thereto. As shown in FIG. 21A, the front wheel stem 110 may be bent to be deviated from the folding unit 170, and the front wheel stem may coincide with the rotary shaft of the saddle.

Here, the above-mentioned configuration may be used for another purpose, in addition to the case in which the ground contact point of the front wheel coincides with the rotary shaft of the saddle.

On the other hand, the rotary shaft of the saddle may be intentionally deviated from the ground contact point of the front wheel. For the convenience of configuration of the present invention, since the center of gravity of the user is formed at a forward side when a caster angle is provided to the front wheel or the user's body is tilted forward upon the riding, the saddle can be moved to allow the center of gravity to further approach the rotary shaft, for the convenience of the steering manipulation, to exert an influence to the steering rotation of the handle stem through the user's weight, and for the purpose of aesthetic appearance.

In FIG. 21B, the front wheel stem can be longitudinally divided into two parts, and the handle stem can be inserted between the two parts to form the folding unit 170. On the other hand, the handle stem may be longitudinally divided into two parts and the front wheel stem can be inserted therebetween.

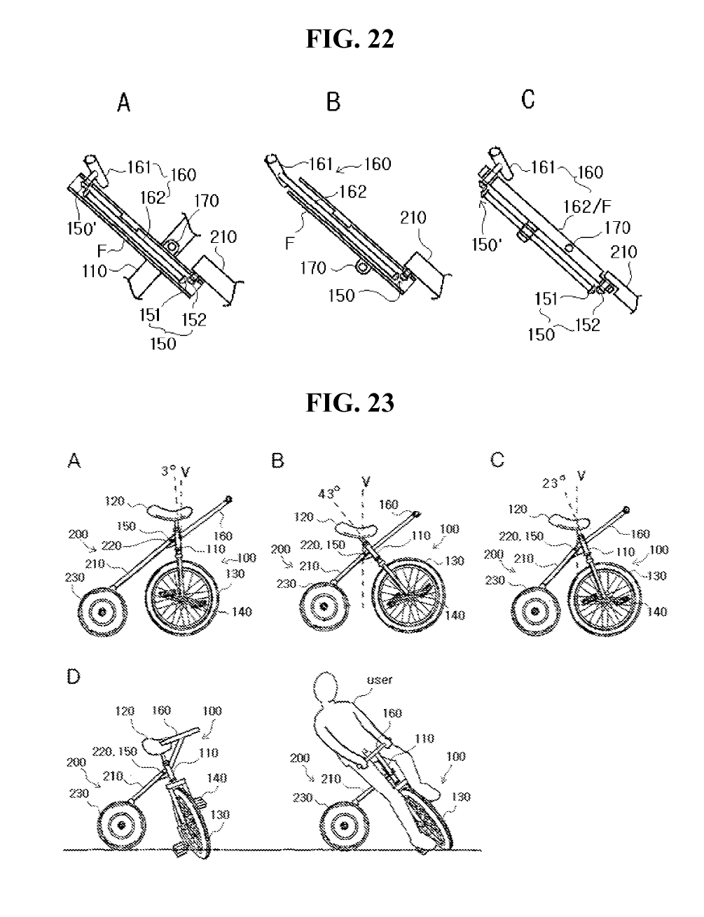

In FIG. 22, various types of handle stems and steering manipulation units are shown. FIGS. 22A and 22C show the case in which a bevel gear (or a universal coupling) is also added to the rotary shaft of the handle 161, and FIG. 22B shows the case in which the housing frame F extends to the handle 161 to substantially function as the handle stem 162. Accordingly, referring to FIG. 22, it will be appreciated that the housing frame F is one element of the handle stem 162 or may be replaced with another.

As shown in FIGS. 16B and 16C, since the respective components are disassembled and assembled, convenience in maintenance, storage and conveyance can be improved.

More specific items or other configurations of all of the components such as the steering manipulation unit 150 may be incorporated by illustrations of FIGS. 1 to 11.

FIG. 23 shows an operation of the present invention.

In FIG. 23A, no inclination angle or a very small inclination angle (3°) of the rotary shaft of the front wheel stem 110, the steering manipulation unit 150 or the steering bearing 220 is applied with respect to a vertical normal line v, which may cause the user to fall down forward.

In FIG. 23B, a very large inclination angle (43°) is provided, and although there is no probability of falling down forward, the user may feel slightly recumbent rearward.

In FIG. 23C, a medium inclination angle (23°) is provided.

The inclination angle may be varied by an apparatus configured to vary the inclination angle according to the user's preference, use, trend, or the like.

According to the present invention, a bicycle body structure is minimized, the weight is reduced, and the volume is minimized Accordingly, use, conveyance and portability of the bicycle become easy, and the user's feet can coincide with a rotational direction of the front wheel to easily step on the pedal upon driving of the front wheel, enabling easy pedaling. As a result, use convenience of the user can be improved to contribute to market base expansion of the bicycle.

1-5. (canceled)

6. A front wheel section steering bicycle comprising:
a front wheel section comprising a handle section, and front wheel stem connected to a lower end of the handle section and provided with a saddle installed at an upper end and a front wheel installed at a lower end thereof; and
a rear wheel section comprising a rear wheel stem provided with an upper end hinged to the lower end of the handle section or the front wheel stem via a steering bearing and a lower end at which a rear wheel is installed,
wherein the front wheel section is laterally steered about a ground contact point of the front wheel as a rotary shaft by the hinge when the steering bearing is rotated by steering manipulation of the handle section.

7. The front wheel section steering bicycle according to claim 6, wherein the steering manipulation changes a rotational angle through gears to rotate the steering bearing.

8. The front wheel section steering bicycle according to claim 6, wherein the steering manipulation changes a rotational angle through a universal coupling to rotate the steering bearing.

9. The front wheel section steering bicycle according to claim 6, wherein the steering manipulation rotates the steering bearing through a belt or a chain.

10. The front wheel section steering bicycle according to claim 6, the front wheel section and the rear wheel section form an X shape.

11. The front wheel section steering bicycle according to claim 10, wherein the X shape is foldable.
